(19) United States
(12) Patent Application Publication
(10) Pub. No.: US 2025/0196324 A1
(43) Pub. Date: Jun. 19, 2025

(54) ROBOT SYSTEM, PROCESSING METHOD, AND RECORDING MEDIUM

(71) Applicant: NEC Corporation, Minato-ku, Tokyo (JP)

(72) Inventors: Masatsugu OGAWA, Tokyo (JP); Hisaya WAKAYAMA, Tokyo (JP); Masumi ICHIEN, Tokyo (JP); Tsutomu MARUYAMA, Tokyo (JP); Youko MORI, Tokyo (JP)

(73) Assignee: NEC Corporation, Minato-ku, Tokyo (JP)

(21) Appl. No.: 18/848,989

(22) PCT Filed: Mar. 29, 2022
(86) PCT No.: PCT/JP2022/015497

§ 371 Date: Sep. 20, 2024

(51) Int. Cl. B25J 9/00

(52) U.S. Cl. CPC B25J 9/0087

(57) ABSTRACT

A robot system is configured to determine whether or not to cause a first robot arm and a second robot arm to grasp a target object and configured to cause the first robot arm and the second robot arm to grasp the target object by causing the first robot arm and the second robot arm to symmetrically operate in a case where it is determined that the first robot arm and the second robot arm are caused to grasp the target object.

### TECHNICAL FIELD

The present disclosure relates to a robot system, a processing method, and a recording medium.

### BACKGROUND ART

Robots are used in various fields such as logistics. In Patent Document 1, technology related to a robot that causes two robot arms to cooperatively operate is disclosed as related technology.

### PRIOR ART DOCUMENTS

### Patent Document

Patent Document 1: Japanese Unexamined Patent Application, First Publication No. 2003-159683

### SUMMARY

### Technical Problem

Human-cooperative robots can advantageously operate in an environment where they coexist with humans in a relatively small size. However, as compared with industrial robots, human-cooperative robots are disadvantageously unable to lift heavy objects and slow. Therefore, there is a need for technology for grasping a target object in a stable state even if it is difficult to grasp the target object with power output by a single robot arm.

An objective of each example aspect of the present disclosure is to provide a robot system, a processing method, and a recording medium capable of solving the above-described problems.

### Solution to Problem

According to an example aspect of the present disclosure, there is provided a robot system including: a robot body; a first robot arm connected to the robot body; a second robot arm provided at a position symmetrical to the first robot arm centered on the robot body and configured to be able to operate symmetrically with the first robot arm; a determination means configured to determine whether or not to cause the first robot arm and the second robot arm to grasp a target object; and a control means configured to cause the first robot arm and the second robot arm to grasp the target object by causing the first robot arm and the second robot arm to operate symmetrically in a case where the determination means determines to cause the first robot arm and the second robot arm to grasp the target object.

According to another example aspect of the present disclosure, there is provided a processing method to be executed by a robot system including a robot body, a first robot arm connected to the robot body, and a second robot arm provided at a position symmetrical to the first robot arm centered on the robot body and configured to be able to operate symmetrically with the first robot arm, the processing method including: determining whether or not to cause the first robot arm and the second robot arm to grasp a target object; and causing the first robot arm and the second robot arm to grasp the target object by causing the first robot arm and the second robot arm to operate symmetrically in a case where it is determined to cause the first robot arm and the second robot arm to grasp the target object.

According to yet another example aspect of the present disclosure, there is provided a recording medium storing a program for causing a computer, which is provided in a robot system including a robot body, a first robot arm connected to the robot body, and a second robot arm provided at a position symmetrical to the first robot arm centered on the robot body and configured to be able to operate symmetrically with the first robot arm, to: determine whether or not to cause the first robot arm and the second robot arm to grasp a target object; and cause the first robot arm and the second robot arm to grasp the target object by causing the first robot arm and the second robot arm to operate symmetrically in a case where it is determined to cause the first robot arm and the second robot arm to grasp the target object.

### Advantageous Effects of Invention

According to each example aspect of the present disclosure, it is possible to grasp a target object in a stable state even if it is difficult to grasp the target object with power output by a single robot arm.

### BRIEF DESCRIPTION OF DRAWINGS

FIG. 1 is a diagram showing an example of a configuration of a robot system according to a first example embodiment of the present disclosure.

FIG. 2 is a diagram showing an example of a database according to the first example embodiment of the present disclosure.

FIG. 3 is a diagram showing an example of a configuration of a host device according to an example embodiment of the present disclosure.

FIG. 4 is a diagram showing an example of a processing flow of the robot system according to the first example embodiment of the present disclosure.

FIG. 5 is a diagram showing an example of a configuration of a robot according to a first modified example of the first example embodiment.

FIG. 6 is a diagram showing a robot system with a minimum configuration according to an example embodiment of the present disclosure.

FIG. 7 is a diagram showing an example of a processing flow of the robot system with the minimum configuration.

FIG. 8 is a schematic block diagram showing a configuration of a computer according to at least one example embodiment.

### EXAMPLE EMBODIMENT

Hereinafter, example embodiments will be described in detail with reference to the drawings.

### Example Embodiment

A robot system 1 according to an example embodiment of the present disclosure can grasp a target object in a stable state even if it is difficult to grasp the target object with power output by a single robot arm by symmetrically operating a first robot arm and a second robot arm. In addition, in the present disclosure, grasping includes holding a target object at a position of a robot arm by suctioning the target object as well as holding a target object at a position of a robot arm by pinching the target object. The robot system 1 is utilized, for example, for receiving goods in a warehouse or the like.

### Configuration of Robot System

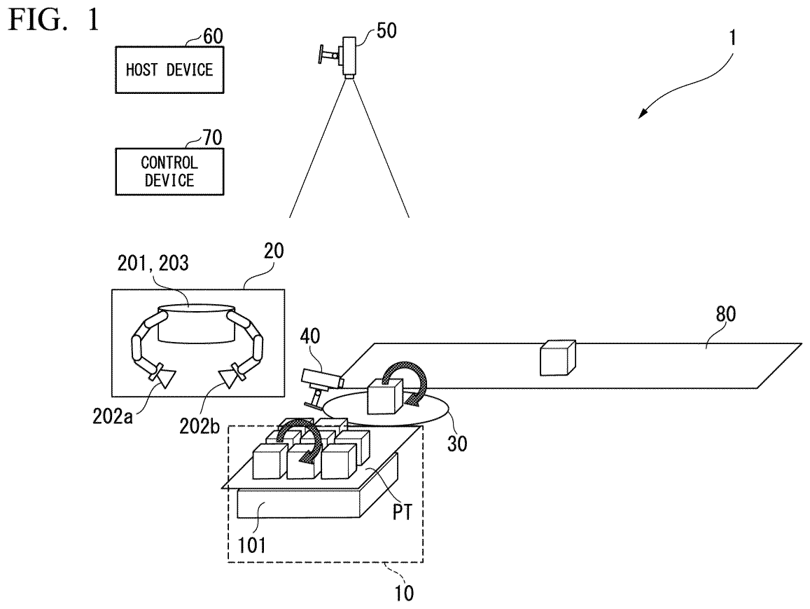

FIG. 1 is a diagram showing an example of a configuration of the robot system 1 according to the first example embodiment of the present disclosure. As shown in FIG. 1, the robot system 1 includes a transport device 10, a robot 20, a rotation mechanism 30, a barcode reader 40, an imaging device 50, a host device 60, a control device 70, and a belt conveyor 80.

As shown in FIG. 1, the transport device 10 includes a transport mechanism 101, a pallet PT, and a database DB. An example of the transport device 10 includes a warehouse management system (WMS) or the like. Based on the database DB, the transport mechanism 101 places a target object (for example, a product in a cardboard box) on the pallet PT, for example, a plurality of products (for example, products A) arriving at the warehouse are placed on the pallet PT, and moves a target object to an area where the robot 20 can operate. The transport mechanism 101 is, for example, an automatic guided vehicle (AGV). Moreover, information indicating the types and number of products that have arrived is recorded for each pallet PT in the database DB. In addition, details of a process of registering information indicating the types and number of products that have arrived in the database DB will be described below.

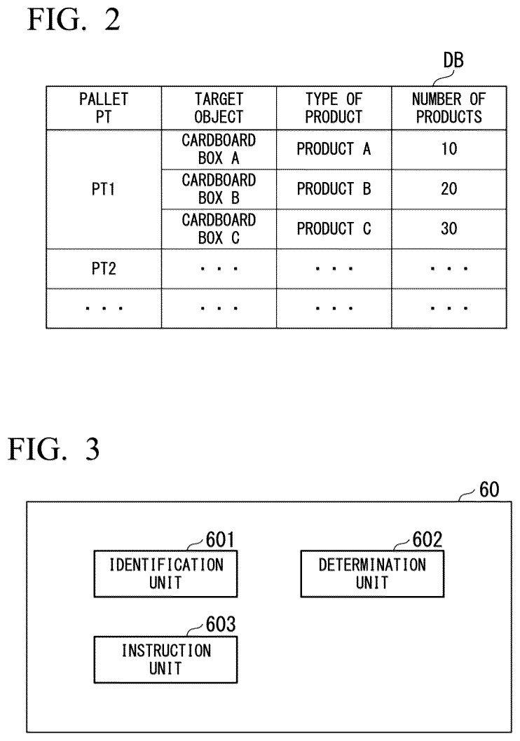

FIG. 2 is a diagram showing an example of the database DB according to the first example embodiment of the present disclosure. In the example of the database DB shown in FIG. 2, it is shown that products A, products B, and products C are arrived wherein cardboard box A, cardboard box B, and cardboard box C are placed on a pallet PT1, 10 products A are contained in cardboard box A, 20 products B are contained in cardboard box B, and 30 products C are contained in cardboard box C. In addition, the types and number of products in each of the cardboard boxes are identified by the barcode reader 40 reading a barcode attached to each of the cardboard boxes, as will be described below.

As shown in FIG. 1, the robot 20 includes a robot body 201, a robot arm 202a (an example of a first robot arm or an example of a second robot arm), a robot arm 202b (an example of a second robot arm or an example of a first robot arm), and a drive mechanism 203. The robot 20 is a human-cooperative robot. Unlike industrial robots, human-cooperative robots are robots that do not need what areas for humans and areas for robots are separated by fences. The robot arm 202a is connected to the robot body 201. The robot arm 202b is provided at a position symmetrical to the robot arm 202a centered on the robot body 201. The robot arm 202b can operate symmetrically with the robot arm 202a. The drive mechanism 203 operates the robot arm 202a and the robot arm 202b. For example, the drive mechanism 203 causes the robot arm 202a and the robot arm 202b to grasp a target object by causing the robot arm 202a and the robot arm 202b to operate symmetrically in accordance with a control signal from the control device 70. Examples of the target object include a cardboard box, a tray, and the like.

The rotation mechanism 30 changes an orientation of the target object. For example, the rotation mechanism 30 is a table on which the robot body 201 or the target object is able to be placed. Specifically, in a case where the rotation mechanism 30 is a table on which the robot body 201 is able to be placed, the target object can face in a direction of the barcode reader 40 by the rotation mechanism 30 rotating in a state in which the robot 20 has grasped the target object. Thereby, the barcode reader 40 can read a barcode attached to the target object. Moreover, specifically, in a case where the rotation mechanism 30 is a table on which the target object is able to be placed, the target object can face in the direction of the barcode reader 40 by the rotation mechanism 30 rotating in a state in which the robot 20 has placed the target object on the rotation mechanism 30. Thereby, the barcode reader 40 can read the barcode attached to the target object.

The barcode reader 40 reads the barcode attached to each target object that has arrived. As described above, what the rotation mechanism 30 rotates and the orientation of the target object changes cause the barcode reader 40 to be able to read the barcode attached to each target object that has arrived.

The imaging device 50 can capture a target object (for example, a cardboard box containing products) placed on the pallet PT that has moved to an area where the robot 20 can operate. The imaging device 50 outputs an image obtained by capturing the target object placed on the pallet PT to the host device 60. The imaging device 50 is, for example, a depth camera.

FIG. 3 is a diagram showing an example of a configuration of the host device 60 according to the example embodiment of the present disclosure. As shown in FIG. 3, the host device 60 includes an identification unit 601, a determination unit 602 (an example of a determination means), and an instruction unit 603.

The identification unit 601 identifies a shape of each target object placed on the pallet PT from the image captured by the imaging device 50. The image captured by the imaging device 50 includes information of a depth direction. Therefore, the identification unit 601 can identify the shape of each target object.

The determination unit 602 determines whether or not to cause the robot arm 202a and the robot arm 202b to grasp a target object. For example, the determination unit 602 acquires processing content of the robot 20. The determination unit 602 determines whether or not the target object is empty based on the acquired processing content. The determination unit 602 can make this determination because it is possible to know how many products have been taken out of the target object if the processing content is known. In a case where it is determined that the target object is not empty, the determination unit 602 determines to cause the robot arm 202a and the robot arm 202b to grasp the target object. This is based on the idea that if there is a product in the target object, it is suitable to grasp the target object with the dual arms of the robot arm 202a and the robot arm 202b from the viewpoint of both a weight and product protection. Moreover, in a case where it is determined that the target object is empty, the determination unit 602 determines to cause the robot arm 202a or the robot arm 202b to grasp the target object. This is based on the idea that it is suitable to grasp the target object with a single arm of the robot arm 202a or the robot arm 202b from the viewpoint that there is no worry that the product will be destroyed and the processing speed is also improved in a case where there is no product in the target object.

In a case where the determination unit 602 determines to cause the robot arm 202a and the robot arm 202b to grasp the target object, the instruction unit 603 outputs an instruction for causing the robot arm 202a and the robot arm 202b to grasp the target object to the control device 70. Moreover, in a case where the determination unit 602 determines to cause the robot arm 202a or the robot arm 202b to grasp the target object, the instruction unit 603 outputs an instruction for causing the robot arm 202a or the robot arm 202b to grasp the target object to the control device 70.

Based on the instruction from the instruction unit 603, the control device 70 causes at least one of the robot arm 202a and the robot arm 202b to grasp the target object. For example, in a case where the instruction unit 603 outputs an instruction for causing the robot arm 202a and the robot arm 202b to grasp the target object to the control device 70, the control device 70 causes the robot arm 202a and the robot arm 202b to grasp the target object. Specifically, the control device 70 causes the robot arm 202a and the robot arm 202b to grasp the target object by causing the robot arm 202a and the robot arm 202b to operate symmetrically. More specifically, in a case where the robot arm 202a is a right arm and the robot arm 202b is a left arm, right-handed coordinates are set for the robot arm 202a and left-handed coordinates are set for the robot arm 202b. Moreover, in a case where the robot arm 202a is a left arm and the robot arm 202b is a right arm, left-handed coordinates are set for the robot arm 202a and right-handed coordinates are set for the robot arm 202b. A right-handed coordinate system is a coordinate system expressed by (positive z-axis direction)=(positive x-axis direction)×(positive y-axis direction) (where×denotes an outer product). A left-handed coordinate system is a coordinate system expressed by (positive z-axis direction)=−(positive x-axis direction)×(positive y-axis direction) (where × denotes an outer product). In a case where the determination unit 602 determines to cause the robot arm 202a and the robot arm 202b to grasp the target object, the control device 70 generates a control signal for operating one of the robot arm 202a and the robot arm 202b. The control device 70 causes the robot arm 202a and the robot arm 202b to operate symmetrically by outputting the generated control signal to the robot arm 202a and the robot arm 202b.

In addition, the same axes (for example, x-, y-, and z-axes) are set for the robot arm 202a and the robot arm 202b and the control device 70 may generate, for each of the robot arm 202a and the robot arm 202b, a control signal operating the robot arm 202a and the robot arm 202b symmetrically and may cause the robot arm 202a and the robot arm 202b to operate.

Moreover, for example, in a case where the instruction unit 603 has output an instruction for causing the robot arm 202a or the robot arm 202b to grasp the target object to the control device 70, the control device 70 causes the robot arm 202a or the robot arm 202b to grasp the target object.

The belt conveyor 80 moves a product whose type has been identified among products that have arrived to a predetermined location.

### Process Performed by Robot System

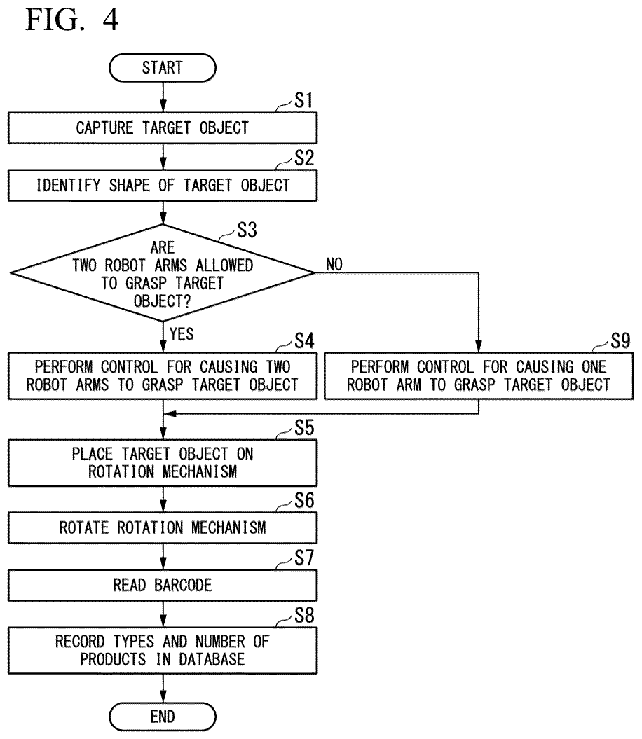

FIG. 4 is a diagram showing an example of a processing flow of the robot system 1 according to the first example embodiment of the present disclosure. Next, a process performed by the robot system 1 will be described with reference to FIG. 4.

The imaging device 50 can capture a target object (for example, a cardboard box containing products) placed on the pallet PT that has moved to an area where the robot 20 can operate (step S1). The imaging device 50 outputs an image obtained by imaging the target object placed on the pallet PT to the host device 60.

The identification unit 601 identifies a shape of each target object placed on the pallet PT from the image captured by the imaging device 50 (step S2).

The determination unit 602 determines whether or not to cause the robot arm 202a and the robot arm 202b to grasp the target object (step S3).

In a case where the determination unit 602 determines to cause the robot arm 202a and the robot arm 202b to grasp the target object (YES in step S3), the instruction unit 603 outputs an instruction for causing the robot arm 202a and the robot arm 202b to grasp the target object to the control device 70. In this case, the control device 70 causes the robot arm 202a and the robot arm 202b to grasp the target object (step S4). Specifically, the control device 70 causes the robot arm 202a and the robot arm 202b to grasp the target object by causing the robot arm 202a and the robot arm 202b to symmetrically operate. The control device 70 causes the robot arm 202a and the robot arm 202b to place the target object on the rotation mechanism 30 (step S5). Also, the control device 70 causes the rotation mechanism 30 to rotate until the barcode reader 40 is oriented to be able to read a barcode (step S6). The barcode reader 40 reads the barcode (step S7). The barcode reader 40 records the types and number of products indicated in the read barcode in the database DB (step S8).

Moreover, in a case where the determination unit 602 determines to cause the robot arm 202a or the robot arm 202b to grasp the target object (NO in step S3), the instruction unit 603 outputs an instruction of causing the robot arm 202a or the robot arm 202b to grasp the target object to the control device 70. In this case, the control device 70 causes the robot arm 202a or the robot arm 202b to grasp the target object (step S9). Also, the control device 70 proceeds to the processing of step S5.

### Advantage

The robot system 1 according to the first example embodiment of the present disclosure has been described above. The robot system 1 includes a robot body 201, a robot arm 202a (an example of a first robot arm), a robot arm 202b (an example of a second robot arm), a determination unit 602 (an example of a determination means), and a control device 70 (an example of a control means). The robot arm 202a is connected to the robot body 201. The robot arm 202b is provided at a position symmetrical to the robot arm 202a centered on the robot body 201. The robot arm 202b can operate symmetrically with the robot arm 202a. The determination unit 602 determines whether or not to cause the robot arm 202a and the robot arm 202b to grasp the target object. In a case where the determination unit 602 determines to cause the robot arm 202a and the robot arm 202b to grasp the target object, the control device 70 causes the robot arm 202a and the robot arm 202b to grasp the target object by causing the robot arm 202a and the robot arm 202b to symmetrically operate.

With this robot system 1, even if it is difficult to grasp a target object with power output by a single robot arm, the target object can be grasped in a stable state.

### Modified Example of Example Embodiment

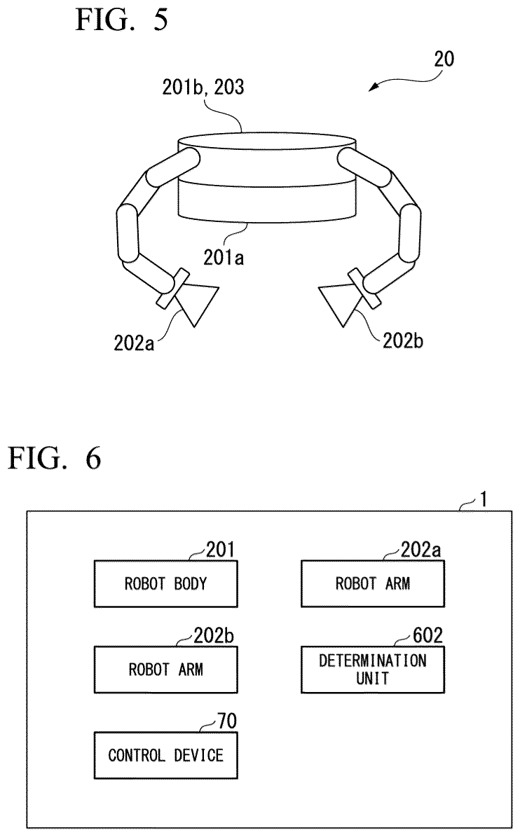

Next, a robot system 1 according to a modified example of the example embodiment of the present disclosure will be described. FIG. 5 is a diagram showing an example of a configuration of a robot 20 according to a first modified example of the first example embodiment. In the first example embodiment, the case where the rotation mechanism 30 is the table on which the robot body 201 or the target object is able to be placed has been described. However, in the first modified example of the first example embodiment, as shown in FIG. 5, the robot body 201 may be divided into a lower first portion 201a and an upper second portion 201b having the same axes and the robot arm 202a and the robot arm 202b may be connected to the second portion 201b. Also, the rotation mechanism 30 may be a mechanism in which the second portion 201b rotates around the axis based on the first portion 201a.

### Advantage

The robot system 1 according to the modified example of the example embodiment of the present disclosure has been described above. This robot system 1 can grasp the target object by symmetrically operating the robot arm 202a and the robot arm 202b and can make a change to an orientation in which the barcode reader 40 easily reads the barcode of the target object by the rotation mechanism 30 that rotates.

In addition, in each example embodiment described above, the case where the instruction unit 603 is included by the host device 60 has been described. However, in another example embodiment, the instruction unit 603 may be included by, for example, the robot 20 or the control device 70, other than the host device 60. Moreover, in another example embodiment, the control device 70 may be included by the robot 20, the host device 60, or the like.

A robot system 1 with a minimum configuration according to an example embodiment of the present disclosure will be described. FIG. 6 is a diagram showing the robot system 1 with the minimum configuration according to the example embodiment of the present disclosure. The robot system 1 with the minimum configuration according to the example embodiment of the present disclosure includes a robot body 201, a robot arm 202a (an example of a first robot arm), a robot arm 202b (an example of a second robot arm), a determination unit 602 (an example of a determination means), and a control device 70 (an example of a control means). The robot arm 202a is connected to the robot body 201. The robot arm 202a can be implemented using, for example, the functions of the robot arm 202a exemplified in FIG. 1. The robot arm 202b is provided at a position symmetrical to the robot arm 202a centered on the robot body 201. The robot arm 202b can operate symmetrically with the robot arm 202a.

The robot arm 202b can be implemented using, for example, the functions of the robot arm 202b exemplified in FIG. 1. The determination unit 602 determines whether or not to cause the robot arm 202a and the robot arm 202b to grasp a target object. The determination unit 602 can be implemented using, for example, the functions of the determination unit 602 exemplified in FIG. 3. In a case where the determination unit 602 determines to cause the robot arm 202a and the robot arm 202b to grasp the target object, the control device 70 causes the robot arm 202a and the robot arm 202b to grasp the target object by causing the robot arm 202a and the robot arm 202b to symmetrically operate. The control device 70 can be implemented using, for example, the functions of the control device 70 exemplified in FIG. 1.

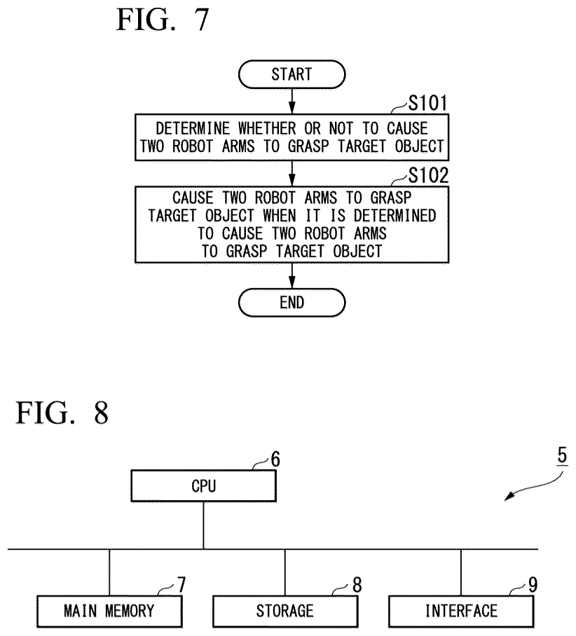

Next, a process of the robot system 1 with the minimum configuration will be described. FIG. 7 is a diagram showing an example of a processing flow of the robot system 1 with the minimum configuration. Here, the process of the robot system 1 with the minimum configuration will be described with reference to FIG. 7.

The robot arm 202a is connected to the robot body 201. The robot arm 202b is provided at a position symmetrical to the robot arm 202a centered on the robot body 201. The robot arm 202b can operate symmetrically with the robot arm 202a. The determination unit 602 determines whether or not to cause the robot arm 202a and the robot arm 202b to grasp a target object (step S101). In a case where the determination unit 602 determines to cause the robot arm 202a and the robot arm 202b to grasp the target object, the control device 70 causes the robot arm 202a and the robot arm 202b to grasp the target object by causing the robot arm 202a and the robot arm 202b to symmetrically operate (step S102). Thereby, the robot system 1 can grasp a target object in a stable state even if it is difficult to grasp the target object with power output by a single robot arm.

Also, in the process in the example embodiment of the present disclosure, the order of processing may be swapped in a range in which the appropriate process is performed.

Although example embodiments of the present disclosure have been described, the above-described robot system 1, the robot 20, the control device 70, and other control devices may include a computer device therein. The process of the above-described processing is stored on a computer-readable recording medium in the form of a program, and the above process is performed by the computer reading and executing the program. A specific example of the computer is shown below.

FIG. 8 is a schematic block diagram showing a configuration of a computer according to at least one example embodiment. As shown in FIG. 8, a computer 5 includes a central processing unit (CPU) 6, a main memory 7, a storage 8, and an interface 9. For example, each of the above-described robot system 1, the robot 20, the control device 70, and other control devices is installed in the computer 5. Also, the operation of each processing unit described above is stored in the storage 8 in the form of a program. The CPU 6 reads the program from the storage 8, loads the program into the main memory 7, and executes the above-described process in accordance with the program. Moreover, the CPU 6 secures a storage area corresponding to each of the above-described storage units in the main memory 7 in accordance with the program.

Examples of the storage 8 include a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like. The storage 8 may be an internal medium directly connected to a bus of the computer 5 or an external medium connected to the computer 5 via the interface 9 or a communication line. Also, in a case where the above program is distributed to the computer 5 via a communication line, the computer 5 receiving the distributed program may load the program into the main memory 7 and execute the above process. In at least one example embodiment, the storage 8 is a non-transitory tangible storage medium.

Moreover, the program may be a program for implementing some of the above-mentioned functions. Furthermore, the program may be a file for implementing the above-described function in combination with another program already stored in the computer system, a so-called differential file (differential program).

Although several example embodiments of the present disclosure have been described, these example embodiments are examples and do not limit the scope of the present disclosure. In relation to these example embodiments, various additions, omissions, substitutions, and other modifications can be made without departing from the spirit or scope of the present disclosure.

### INDUSTRIAL APPLICABILITY

According to each example aspect of the present disclosure, it is possible to grasp a target object in a stable state even if it is difficult to grasp the target object with power output by a single robot arm.

### REFERENCE SIGNS LIST

1 Robot system
5 Computer
6 CPU
7 Main memory
8 Storage
9 Interface
10 Transport device
20 Robot
30 Rotation mechanism
40 Barcode reader
50 Imaging device
60 Host device
70 Control device
80 Belt conveyor
101 Transport mechanism
201 Robot body
202a, 202b Robot arm
203 Drive mechanism
601 Identification unit
602 Determination unit
603 Instruction unit
DB Database
PT Pallet

What is claimed is:

1. A robot system comprising:
a robot body;
a first robot arm connected to the robot body;
a second robot arm provided at a position symmetrical to the first robot arm centered on the robot body and configured to be able to operate symmetrically with the first robot arm;
a memory configured to store instructions; and
a processor configured to execute the instructions to:
determine whether or not to cause the first robot arm and the second robot arm to grasp a target object; and
cause the first robot arm and the second robot arm to grasp the target object by causing the first robot arm and the second robot arm to operate symmetrically in a case where it is determined that the first robot arm and the second robot arm are caused to grasp the target object.

2. The robot system according to claim 1,
wherein right-handed coordinates are set for the first robot arm and left-handed coordinates are set for the second robot arm in a case where the first robot arm is a right arm and the second robot arm is a left arm,
wherein left-handed coordinates are set for the first robot arm and right-handed coordinates are set for the second robot arm in a case where the first robot arm is a left arm and the second robot arm is a right arm, and
wherein the processor is configured to generate a control signal for operating one of the first robot arm and the second robot arm in a case where it is determined that the first robot arm and the second robot arm are caused to grasp the target object and cause the first robot arm and the second robot arm to operate symmetrically by outputting the generated control signal to the first robot arm and the second robot arm.

3. The robot system according to claim 1, comprising a turntable configured to change an orientation of the target object.

4. The robot system according to claim 3, wherein the turntable is a table on which the robot body or the target object is able to be placed.

5. The robot system according to claim 3,
wherein the robot body is divided into a lower first portion and an upper second portion including the same axes,
wherein the first robot arm and the second robot arm are connected to the second portion, and
wherein the turntable is a table in which the second portion rotates around the axis based on the first portion.

6. The robot system according to claim 1, wherein the processor is configured to cause the first robot arm or the second robot arm to grasp the target object in a case where it is determined that only one of the first robot arm and the second robot arm is caused to grasp the target object.

7. A processing method to be executed by a robot system including a robot body, a first robot arm connected to the robot body, and a second robot arm provided at a position symmetrical to the first robot arm centered on the robot body and configured to be able to operate symmetrically with the first robot arm, the processing method comprising:
determining whether or not to cause the first robot arm and the second robot arm to grasp a target object; and
causing the first robot arm and the second robot arm to grasp the target object by causing the first robot arm and the second robot arm to operate symmetrically in a case where it is determined to cause the first robot arm and the second robot arm to grasp the target object.

8. A non-transitory recording medium storing a program for causing a computer, which is included by a robot system including a robot body, a first robot arm connected to the robot body, and a second robot arm provided at a position symmetrical to the first robot arm centered on the robot body and configured to be able to operate symmetrically with the first robot arm, to:
determine whether or not to cause the first robot arm and the second robot arm to grasp a target object; and
cause the first robot arm and the second robot arm to grasp the target object by causing the first robot arm and the second robot arm to operate symmetrically in a case where it is determined to cause the first robot arm and the second robot arm to grasp the target object.
